(19) United States
(12) Patent Application Publication
(10) Pub. No.: US 2026/0354477 A1
(43) Pub. Date: Nov. 12, 2026

(54) FLAVOR INHALATION SYSTEM

(71) Applicant: Japan Tobacco Inc., Tokyo (JP)

(72) Inventors: Manabu YAMADA, Tokyo (JP); Hirofumi MATSUMOTO, Tokyo (JP); Yusuke IKAI, Tokyo (JP)

(73) Assignee: Japan Tobacco Inc., Tokyo (JP)

(21) Appl. No.: 19/139,873

(22) PCT Filed: Dec. 26, 2022
(86) PCT No.: PCT/JP2022/047878

§ 371 Date: Jun. 17, 2025

(51) Int. Cl. A24F 40/46; A24B 15/32; A24D 1/00; A24D 1/20; A24D 1/22; A24F 40/20

(52) U.S. Cl. CPC A24F 40/46; A24B 15/32; A24D 1/002; A24D 1/20; A24D 1/22; A24F 40/20

(57) ABSTRACT

Provided is a flavor inhalation system. This flavor inhalation system comprises: a flavor generating article having a flavor source that generates a flavor upon being heated; and a flavor inhaler having a housing portion that houses the flavor source and an antenna that emits microwaves. A first region including a region in which the electric field intensity of microwaves emitted from the antenna is strongest and a second region in which the electric field intensity is weaker than that in the first region are formed in the housing portion. The flavor source includes a first portion corresponding to the first region and a second portion corresponding to the second region when the flavor generating article is positioned in a desired position of the flavor inhaler. The first portion includes no carbonizable substance that is easily carbonized by heating, and the second portion includes a carbonizable substance.

### TECHNICAL FIELD

The present invention relates to a flavor inhalation system.

### BACKGROUND ART

Conventionally, flavor inhalation systems for inhaling flavors, etc., without burning materials are known (see, for example, PTL 1 and PTL 2). One such known flavor inhalation system uses microwaves to heat a flavor source that generates flavor when heated (see, for example, PTL 3).

### CITATION LIST

### Patent Literature

PTL 1 WO 2020/002165 A1

PTL 2 WO 2020/007879 A1

PTL 3 CN 110876492 A

### SUMMARY OF INVENTION

### Technical Problem

In the flavor inhalation system disclosed in PTL 3, when the flavor source is heated by microwaves, some substances contained in the flavor source may be excessively heated and carbonized, adversely affecting the smoking flavor.

The present invention has been devised to solve at least part of the above problem and has as an object to prevent the carbonization of substances contained in the flavor source.

### Solution to Problem

In the first aspect of the present invention, a flavor inhalation system is provided. This flavor inhalation system comprises a flavor generating article having a flavor source that is heated to generate flavor, and a flavor inhaler having an accommodating section for accommodating the flavor source and an antenna for emitting microwaves, wherein a first region including the region where the electric field intensity of the microwaves emitted from the antenna is strongest and a second region where the electric field intensity is weaker than in the first region are formed in the accommodating section, the flavor source, when the flavor generating article is positioned at a desired position in the flavor inhaler, includes a first portion corresponding to the first region and a second portion corresponding to the second region, the first portion does not contain carbonizable substances that easily carbonize upon heating, and the second portion contains carbonizable substances.

According to the first aspect of the present invention, by including carbonizable substances that easily carbonize upon heating in the second portion corresponding to the second region where the electric field intensity is weaker than in the first region, it is possible to prevent the carbonization of carbonizable substances by microwave heating. Therefore, it is possible to prevent the carbonization of substances contained in the flavor source.

According to the second aspect of the present invention, in the first aspect, the antenna is a pin-type antenna inserted along the longitudinal direction of the flavor generating article, the first region is a region near the tip of the pin-type antenna, and the second region is a region near the base end of the pin-type antenna.

With the second aspect of the present invention, by including carbonizable substances that easily carbonize upon heating in the second portion corresponding to the second region near the base end of the pin-type antenna, it is possible to prevent the carbonization of carbonizable substances by microwave heating. Therefore, it is possible to prevent the carbonization of substances contained in the flavor source.

According to the third aspect of the present invention, in the first aspect, the antenna is a pin-type antenna inserted along the longitudinal direction of the flavor generating article, the first region is a region near the tip of the pin-type antenna, and the second region is a region on the opposite side of the tip of the pin-type antenna to the base end of the pin-type antenna.

With the third aspect of the present invention, by including carbonizable substances that easily carbonize upon heating in the second portion corresponding to the second region on the opposite side of the base end of the pin-type antenna relative to the tip, it is possible to prevent the carbonization of carbonizable substances by microwave heating. Therefore, it is possible to prevent the carbonization of substances contained in the flavor source.

According to the fourth aspect of the present invention, in the second or third aspect, the flavor source has a hollow portion into which the pin-type antenna can be inserted.

With the fourth aspect of the present invention, by inserting the pin-type antenna into the hollow portion of the flavor source, the flavor source does not adhere closely to the pin-type antenna. Therefore, it is possible to prevent the adhesion of components of the heated flavor source to the pin-type antenna.

According to the fifth aspect of the present invention, in any of the second to fourth aspects, when the flavor generating article is positioned at a desired position in the flavor inhaler, the tip of the pin-type antenna is arranged to overlap with the flavor source in the longitudinal direction of the flavor generating article.

With the fifth aspect of the present invention, by arranging the tip of the pin-type antenna with strong electric field intensity to overlap with the flavor source in the longitudinal direction of the flavor generating article, it is possible to efficiently transmit microwaves emitted from the pin-type antenna to the flavor source.

According to the sixth aspect of the present invention, in the first aspect, the first region is a region close to the antenna in a direction orthogonal to the longitudinal direction of the flavor generating article, and the second region is a region far from the antenna in a direction orthogonal to the longitudinal direction.

With the sixth aspect of the present invention, by including carbonizable substances that easily carbonize upon heating in the second portion corresponding to the second region far from the antenna, it is possible to prevent the carbonization of carbonizable substances by microwave heating. Therefore, it is possible to prevent the carbonization of substances contained in the flavor source.

According to the seventh aspect of the present invention, in any of the first to sixth aspects, the first portion includes an aerosol generating substance that generates aerosol when heated, and the second portion includes a flavor generating substance that generates flavor when heated.

With the seventh aspect of the present invention, it is possible to mix the aerosol generated in the first portion with the flavor generated in the second portion in the flavor source.

According to the eighth aspect of the present invention, in the seventh aspect citing the second aspect, the flavor generating article further includes an outer member surrounding the outer periphery of the flavor source and forming a gap with the flavor source, a first air passage formed in the outer member and the first portion and allowing the exterior of the flavor generating article to communicate with at least the first portion in a sealed manner, and a second air passage formed in the second portion and allowing at least the second portion to communicate with the gap.

With the eighth aspect of the present invention, since an air passage is formed in which air flowing in from the exterior of the flavor generating article passes through the first air passage, the first portion, the second portion, the second air passage, and the gap in sequence, it is possible to efficiently mix the flavor generated in the second portion with the aerosol generated in the first portion.

According to the ninth aspect of the present invention, in the seventh aspect citing the sixth aspect, the flavor generating article further includes an outer member surrounding the outer periphery of the flavor source and forming a gap with the flavor source, a third air passage formed on the proximal end side of the flavor generating article in the outer member, the first portion, and the second portion, and allowing the exterior of the flavor generating article to communicate with at least the first portion in a sealed manner, and a fourth air passage formed on the distal end side of the flavor generating article in at least the second portion, and allowing at least the second portion to communicate with the gap.

With the ninth aspect of the present invention, since an air passage is formed in which air flowing in from the exterior of the flavor generating article passes through the third air passage, the first portion, the second portion, the fourth air passage, and the gap in sequence, it is possible to efficiently mix the flavor generated in the second portion with the aerosol generated in the first portion.

According to the tenth aspect of the present invention, in the seventh aspect citing the sixth aspect, the flavor source has a hollow portion into which the antenna can be inserted, and the flavor generating article further includes an outer member surrounding the outer periphery of the flavor source and forming a gap with the flavor source, a fifth air passage formed in the hollow portion, and a sixth air passage formed in the gap, having a smaller flow path area than the fifth air passage, and merging with the fifth air passage before reaching the proximal end of the flavor generating article.

With the tenth aspect of the present invention, by inserting the antenna into the hollow portion of the flavor source, the flavor source does not adhere closely to the antenna. Therefore, it is possible to prevent the adhesion of components of the heated flavor source to the antenna. Additionally, since the fast-flowing flavor generated in the second portion and passing through the sixth air passage is mixed with the aerosol generated in the first portion and passing through the fifth air passage before reaching the proximal end of the flavor generating article, it is possible to efficiently mix the aerosol and the flavor.

According to the eleventh aspect of the present invention, in any of the first to tenth aspects, the second portion includes a microwave absorber that absorbs microwaves and generates heat.

With the eleventh aspect of the present invention, by including a microwave absorber in the second portion, it is possible to efficiently heat the second portion.

According to the twelfth aspect of the present invention, in any of the first to eleventh aspects, a distance between the tip of the antenna in the longitudinal direction of the flavor generating article and the second portion is 0.1 mm or more.

With the twelfth aspect of the present invention, by setting the distance between the tip of the antenna in the longitudinal direction of the flavor generating article and the second portion to 0.1 mm or more, it is possible to further prevent the carbonization of carbonizable substances by microwave heating.

### BRIEF DESCRIPTION OF DRAWINGS

FIG. 1 is a schematic side sectional view of a flavor inhalation system according to an embodiment of the present invention.

FIG. 2 is a schematic side sectional view of a flavor generating article according to an embodiment of the present invention.

FIG. 3 is a schematic diagram representing the electric field intensity distribution of microwaves emitted from the pin-type antenna shown in FIG. 1.

FIG. 4 is an enlarged sectional view showing a part of the flavor inhalation system shown in FIG. 1.

FIG. 5 is a schematic diagram showing the flow of air in the flavor generating article.

FIG. 6 is a sectional view of the flavor source along A-A shown in FIG. 5.

FIG. 7 is a sectional view of the flavor source along view B-B shown in FIG. 5.

FIG. 8 is another schematic diagram showing the flow of air in the flavor generating article.

FIG. 9 is another enlarged sectional view showing a part of the flavor inhalation system shown in FIG. 1.

FIG. 10 is yet another enlarged sectional view showing a part of the flavor inhalation system shown in FIG. 1.

FIG. 11 is yet another schematic diagram showing the flow of air in the flavor generating article.

FIG. 12 is a sectional view of the flavor source along C-C shown in FIG. 11.

FIG. 13 is a sectional view of the flavor source along D-D shown in FIG. 11.

FIG. 14 is yet another schematic diagram showing the flow of air in the flavor generating article.

FIG. 15 is yet another schematic diagram showing the flow of air in the flavor generating article.

### DESCRIPTION OF EMBODIMENTS

The embodiments of the present invention will be described below with reference to the drawings. In the drawings described below, the same or corresponding components are denoted by the same reference numerals, and redundant descriptions are omitted. It should be noted that the “longitudinal direction” in the present specification means the longitudinal direction of the flavor generating article, in other words, the direction of insertion of the flavor-generating article into the flavor inhaler.

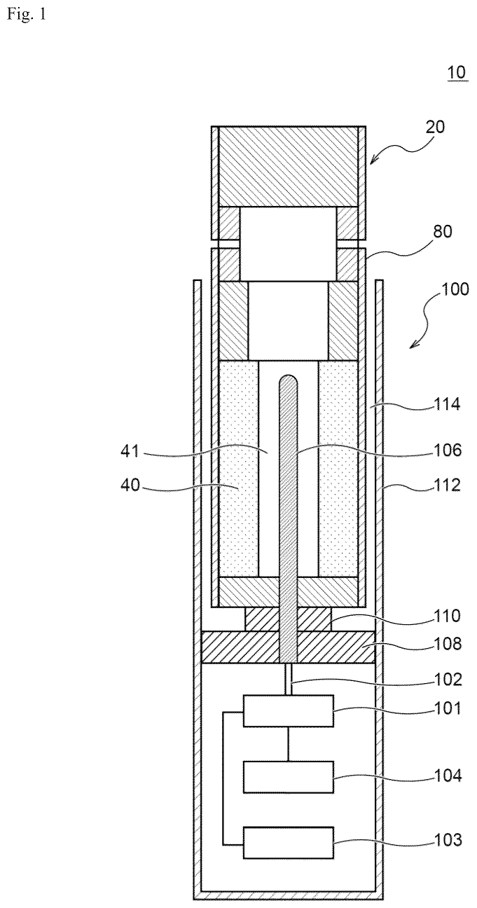

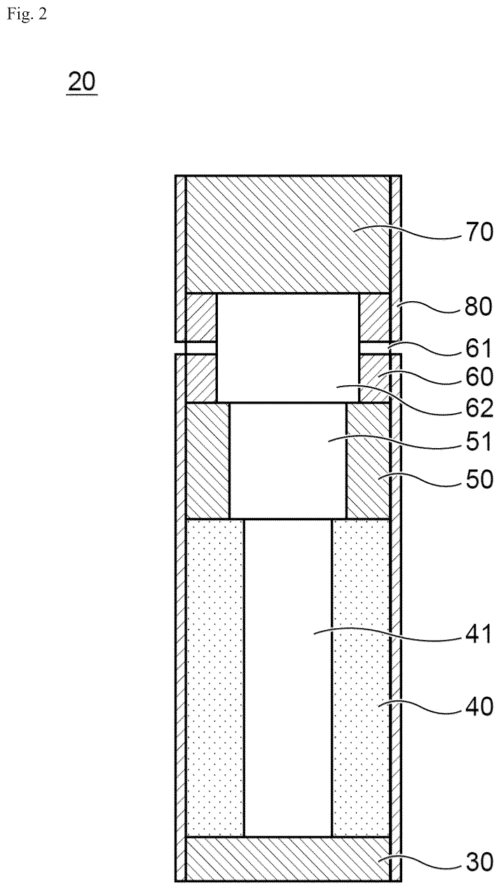

FIG. 1 is a schematic side sectional view of a flavor inhalation system according to an embodiment of the present invention. FIG. 2 is a schematic side sectional view of a flavor generating article according to an embodiment of the present invention. As shown in FIG. 1, a flavor inhalation system 10 according to this embodiment includes a flavor generating article 20 and a flavor inhaler 100. The flavor inhaler 100 is preferably a portable or handheld device.

As shown in FIG. 1, the flavor inhaler 100 includes a high-frequency oscillation unit 101, a waveguide 102, a battery 103, a PCB (Printed Circuit Board) 104, a pin-type antenna 106, an antenna mount 108, a support section 110, a housing 112, and a chamber (accommodating section) 114. The flavor generating article 20 includes a flavor source 40 that is heated by the flavor inhaler 100 to generate flavor. The detailed configuration of the flavor generating article 20 will be described later.

The flavor inhaler 100 is configured to atomize the flavor generating substances and aerosol generating substances contained in the flavor source 40. The flavor source 40 constitutes part of the flavor generating article 20, which extends in a columnar shape along the longitudinal direction. The flavor generating article 20 may be, for example, a tobacco stick containing tobacco as the flavor source 40.

In the illustrated example, the flavor inhaler 100 is configured to accommodate the columnar-shaped flavor generating article 20. As shown, the high-frequency oscillation unit 101, waveguide 102, battery 103, PCB 104, pin-type antenna 106, antenna mount 108, and support section 110 may be arranged in the direction in which the flavor generating article 20 is inserted into the flavor inhaler 100. The housing 112 is a casing that accommodates the high-frequency oscillation unit 101, waveguide 102, battery 103, PCB 104, pin-type antenna 106, antenna mount 108, and support section 110.

The high-frequency oscillation unit 101 is, for example, a solid-state oscillator that generates a high-frequency electromagnetic field of a predetermined frequency. The solid-state oscillator may be, for example, an LDMOS transistor, GaAs FET, SIC MESFET, or GaN HFET. In this specification, “high-frequency electromagnetic field” means a high-frequency electromagnetic field between 3 Hz and 3 THz. “Microwave” means a high-frequency electromagnetic field between 300 MHz and 300 GHz. The high-frequency oscillation unit 101 is not particularly limited but can generate microwaves with a frequency of 2.40 to 2.50 GHz. In this embodiment, the high-frequency oscillation unit 101 generates microwaves with a frequency of 2.45 GHz.

The high-frequency oscillation unit 101 may include an amplifier for amplifying the high-frequency electromagnetic field. The high-frequency oscillation unit 101 itself may have the function of an amplifier, or an amplifier may be provided using electronic components separate from the high-frequency oscillation unit 101.

While there are also magnetron-type oscillators as devices for generating high-frequency electromagnetic fields, using a solid-state oscillator as the high-frequency oscillation unit 101 allows for a more compact body compared to using a magnetron-type oscillator. Additionally, a solid-state oscillator can operate at a lower operating voltage compared to a magnetron-type oscillator and has higher frequency stability and output stability. However, the high-frequency oscillation unit 101 of this embodiment only needs to be able to generate a high-frequency electromagnetic field of a predetermined frequency and may be a magnetron-type oscillator.

The microwaves generated by the high-frequency oscillation unit 101 propagate through the waveguide 102 and are guided to the pin-type antenna 106. Instead of the waveguide 102, a coaxial cable may be used. Additionally, if the high-frequency oscillation unit 101 and the pin-type antenna 106 are directly connected, the waveguide 102 or coaxial cable may be omitted.

The waveguide 102 connects the high-frequency oscillation unit 101 and the pin-type antenna 106 and guides the microwaves generated by the high-frequency oscillation unit 101 to the pin-type antenna 106. The waveguide 102 may be provided with an isolator that absorbs reflected waves that are not absorbed by the flavor generating article 20 and return toward the high-frequency oscillation unit 101, thereby protecting the high-frequency oscillation unit 101. Additionally, the waveguide 102 may be provided with a power monitor that detects the power of the incident wave from the high-frequency oscillation unit 101 and the power of the reflected wave from the flavor generating article 20, and an impedance matching section that matches the impedance on the high-frequency oscillation unit 101 side with the impedance on the flavor generating article 20 side to reduce the power of the reflected wave.

The battery 103 stores electrical power used by the flavor inhaler 100. Specifically, the battery 103 can supply power to the high-frequency oscillation unit 101 and the PCB 104. The battery 103 is a lithium ion battery, for example. The battery 103 may be rechargeable by means of an external power source.

The PCB 104 is composed of a CPU and memory, etc., and controls the operation of the flavor inhaler 100. For example, the PCB 104 starts heating of the flavor source 40 in response to a user operation on an input device such as a push-button or slide switch (not depicted), and terminates heating of the flavor source 40 once a given time has elapsed.

When the number of puff operations by the user has passed a fixed value, the PCB 104 may terminate heating of the flavor source 40 even if the given time has not yet elapsed from the start of heating of the flavor source 40. For example, the puff operation is detected by a sensor (not shown).

The PCB 104 may start heating the flavor source 40 in response to the start of a puff operation and stop heating the flavor source 40 in response to the end of the puff operation. The PCB 104 may stop heating the flavor source 40 even before the end of the puff operation if a certain period has elapsed from the start of the puff operation. In the flavor inhaler 100 according to this embodiment, the PCB 104 is disposed between the battery 103 and the high-frequency oscillation unit 101.

The pin-type antenna 106 has a shape that can be inserted into the flavor source 40 along the longitudinal direction and is configured to irradiate microwaves from the inside to the flavor source 40. The pin-type antenna 106 is arranged to overlap with the flavor source 40 in the longitudinal direction when the flavor generating article 20 is positioned at a desired position in the flavor inhaler 100.

In this specification, “when the flavor generating article 20 is positioned at a desired position in the flavor inhaler 100” means that the flavor generating article 20 is correctly positioned at the intended position in the flavor inhaler 100 to generate flavor or aerosol from the flavor generating article 20.

The antenna length of the pin-type antenna 106 can be appropriately set according to the frequency of the high-frequency electromagnetic waves to be irradiated. For example, when the frequency of the microwaves generated by the pin-type antenna 106 is 2.45 GHZ (wavelength is about 120 mm), the antenna length can be set to about 30 mm (i.e., ¼ wavelength). The antenna diameter is, for example, 1 mm. Note that the shape of the pin-type antenna 106 is not limited to a cylindrical shape and may be, for example, a flat plate shape or a shape with a chamfered tip.

The antenna mount 108 is a member for attaching the pin-type antenna 106 to the housing 112. The antenna mount 108 may define the bottom of the chamber 114 in which at least the flavor source 40 of the flavor generating article 20 is accommodated within the housing 112. Note that a shielding member such as a metal mesh with openings smaller than the half-wavelength of microwaves may be arranged on the inner surface of the housing 112 corresponding to the chamber 114 to prevent electromagnetic wave leakage in the direction of the mouthpiece, surrounding the accommodating space for the flavor generating article 20.

The support section 110 is provided on the antenna mount 108 and is a member for supporting the upstream end of the flavor generating article 20. Additionally, an air passage for supplying air to the upstream end of the flavor generating article 20 may be formed on the side of the support section 110. The antenna mount 108 and the support section 110 may be formed of a material that substantially does not absorb microwaves, with a relative permittivity of 10 or less.

The flavor inhaler 100 may include a thermocouple or radiation thermometer configured to detect the temperature at any location within the flavor inhaler 100, such as within the chamber 114, to control the power of the microwaves. The PCB 104 can control the power supplied to the pin-type antenna 106 based on the detection data from the thermocouple or radiation thermometer. Note that the PCB 104 may control the power supplied to the pin-type antenna 106 by detecting the dielectric constant or impedance, which changes with heating, of any member of the flavor inhaler 100, such as the chamber 114.

Additionally, the flavor inhaler 100 may include a notification section for notifying the user of information based on control by the PCB 104. The information notified to the user includes, for example, detection of the insertion of the flavor generating article 20, the start of heating by microwaves, the transition to a state where aerosol can be inhaled, error information, the remaining amount of the battery 103, etc. The notification section may be composed of a light-emitting element such as an LED, a vibrating element such as a vibration motor, or a sound output element. The notification section may be a combination of two or more elements among the light-emitting element, vibrating element, and sound output element.

Additionally, the flavor inhaler 100 may include a communication section that acquires information about the usage state of the flavor inhaler 100 and transmits it to an external data server or the user's mobile terminal device (hereinafter referred to as a data server, etc.), and also receives data from the data server, etc. For example, the communication section transmits information about the usage state of the flavor inhaler 100, such as error information and usage date and time information, to the data server, etc. This allows the manufacturer of the flavor inhaler 100 to grasp the usage state of the flavor inhaler 100 and create information about firmware updates to be built into the PCB 104. The communication section can receive information about firmware updates.

The communication section can communicate with the data server, etc., via short-range wireless communication such as Bluetooth (registered trademark) or long-range wireless communication such as LPWA (Low Power Wide Area). Note that communication between the communication section and the data server, etc., is not limited to the above-mentioned wireless communication and may be other forms of wireless communication or wired communication.

As shown in FIG. 2, the flavor generating article 20 according to this embodiment may include a plug element 30, a flavor source 40, a support element 50, a cooling element 60, and a filter element 70. In the direction in which the flavor generating article 20 is inserted into the flavor inhaler 100, the plug element 30, flavor source 40, support element 50, cooling element 60, and filter element 70 are arranged adjacent to each other in this order and are wrapped with tip paper (outer member) 80. Note that the flavor generating article 20 only needs to include at least the flavor source 40, and other configurations may be omitted as appropriate. Additionally, the flavor generating article 20 may include a shielding member such as a metal mesh with openings smaller than the half-wavelength of microwaves to prevent electromagnetic wave leakage in the direction of the mouthpiece.

Here, the flavor generating article 20 may be configured with the plug element 30 and flavor source 40 wrapped by a wrapper (outer member) (not shown), and the support element 50, cooling element 60, and filter element 70 arranged side by side, with the flavor source 40, support element 50, cooling element 60, and filter element 70 wrapped by tip paper 80. Alternatively, the flavor generating article 20 may have the plug element 30, flavor source 40, and support element 50 wrapped by a wrapper, and the cooling element 60 and filter element 70 wrapped by a wrapper, with the support element 50, cooling element 60, and filter element 70 wrapped by tip paper 80.

In this specification, “filter” is not limited to a member that filters some object but includes any breathable member. Specifically, for example, a “filter” includes a breathable member with one or more communication holes or one or more grooves or notches. The material forming the “filter” may be a porous material that is breathable by itself or a material that is not breathable by itself (e.g., glass, ceramic, cellulose molded body).

The plug element 30 is positioned upstream of the flavor source 40. The plug element 30 may be, for example, an acetate filter, a neo-filter, or a paper filter. The plug element 30 may be in contact with the tip paper (outer member) 80. The plug element 30 prevents the flavor source 40 from falling out of the flavor generating article 20. Additionally, the plug element 30 may be a center-hole filter with a hollow portion into which the pin-type antenna 106 can be inserted. The diameter of the hollow portion of the plug element 30 may be smaller, larger, or substantially the same as the diameter of the hollow portion 41 of the flavor source 40, which will be described later.

The flavor source 40 includes a first portion containing an aerosol generating substance that generates aerosol when heated and a second portion containing a flavor generating substance that generates flavor when heated. This allows the mixing of the aerosol generated in the first portion with the flavor generated in the second portion in the flavor source 40. The arrangement of the first portion and second portion in the flavor source 40 will be described later. Here, the second portion includes carbonizable substances that easily carbonize upon heating, which will be described later, and the first portion does not contain carbonizable substances.

The length of the flavor source 40 may be less than or equal to the antenna length of the pin-type antenna 106, and the ratio of the length LI of the flavor source 40 to the antenna length L2 of the pin-type antenna 106 (L1/L2) may be 1.0 or less.

The first portion of the flavor source 40 includes, for example, a carrier composed of raw materials such as glass, rock wool, or ceramic, and an aerosol generating substance supported on the carrier. The carrier may be glass fiber filter paper or nonwoven fabric. The type of aerosol generating substance is not particularly limited, and extracts and/or components from various natural substances can be selected according to the application. The aerosol generating substance is preferably a polyhydric alcohol, such as glycerin, propylene glycol, triacetin, 1,3-butanediol, and mixtures thereof.

The second portion of the flavor source 40 may include a flavor generating substance. The flavor generating substance is a substance that generates flavor when heated. The flavor generating substance may include tobacco, for example. Specific examples of tobacco include shredded dried tobacco leaves, leaf tobacco powder, or tobacco extracts (extracted with water, organic solvents, or mixed solutions thereof). Note that the flavor generating substance may not include tobacco.

The second portion of the flavor source 40 includes carbonizable substances. Examples of carbonizable substances include fiber components such as pulp or cellulose and binders. The carbonizable substances may be fiber components contained in tobacco or fiber components that can be added to the second portion as fillers. Such carbonizable substances may have the function of maintaining the shape of the second portion of the flavor source 40.

The second portion of the flavor source 40 may include an aerosol generating substance. The type of aerosol generating substance is not particularly limited, and extracts and/or components from various natural substances can be selected according to the application. The aerosol generating substance is preferably a polyhydric alcohol, such as glycerin, propylene glycol, triacetin, 1,3-butanediol, and mixtures thereof.

The second portion of the flavor source 40 may include a binder. Examples of binders include guar gum, xanthan gum, CMC (carboxymethyl cellulose), CMC-Na (sodium salt of carboxymethyl cellulose), HPC (hydroxypropyl cellulose), alginic acid, and sodium alginate. The binder content is preferably 1% by weight or more and 15% by weight or less relative to the total weight of the flavor source 40.

The first and second portions of the flavor source 40 may have any form, such as chopped, sheet, particle, granule, paste, gel, lump, or molded body. The first and second portions of the flavor source 40 may have different forms. Additionally, the first and second portions of the flavor source 40 may be formed on the inner surface of the wrapper or tip paper 80. In this case, the first and second portions of the flavor source 40 may be directly formed on the inner surface of the wrapper or tip paper 80 by printing or the like.

When the first and second portions of the flavor source 40 are in sheet form, sheets manufactured by known methods such as papermaking, slurry, or rolling can be used. In the case of papermaking, they can be manufactured by a method including the following steps. 1) Dried tobacco leaves such as shredded tobacco or tobacco granules are coarsely crushed, extracted with water, and separated into a water extract and residue. 2) The water extract is concentrated by vacuum drying. 3) Pulp or cellulose is added to the residue, fiberized with a refiner, and paper is made. 4) The concentrated water extract is added to the paper-made sheet and dried.

In the case of the slurry method, manufacturing can be done by a method including the following steps. 1) Water, pulp or cellulose, and binder are mixed with crushed tobacco leaves. 2) The mixture is thinly spread (cast) and dried. In the case of the rolling method, manufacturing can be done by a method including the following steps. 1) Water, pulp or cellulose, and binder are mixed with crushed tobacco leaves. 2) The mixture is extruded into a sheet and dried.

When the first and second portions of the flavor source 40 are in sheet form, the thickness of the first and second portions of the flavor source 40 is preferably 0.1 mm or more and 2.0 mm or less, 0.2 mm or more and 1.5 mm or less, and more preferably 0.2 mm or more and 0.6 mm or less. Additionally, when the first and second portions of the flavor source 40 are in sheet form, the first and second portions of the flavor source 40 may be crumpled, folded, or cut into strips. When the sheet-like first and second portions of the flavor source 40 are cut into strips, the width of the strips may be, for example, 0.1 mm or more and 2.0 mm or less.

When the first and second portions of the flavor source 40 are in particle or granule form, the average particle diameter of the flavor source 40 may be, for example, 0.1 mm or more and 3.0 mm or less. When the first and second portions of the flavor source 40 are molded bodies, the flavor source 40 may be a porous body. Additionally, when the first and second portions of the flavor source 40 are molded bodies, the flavor source 40 may have a honeycomb structure. Additionally, the first and second portions of the flavor source 40 may be molded bodies with a hollow portion 41. Additionally, the molded body may be an extruded molded body or a tablet molded body.

The materials containing the aerosol generating substance in the first portion and the flavor generating substance in the second portion of the flavor source 40 can be heated by microwaves emitted from the pin-type antenna 106. The filling amount of the material containing the flavor generating substance in the second portion of the flavor source 40 is, for example, 100 mg or more and 350 mg or less, preferably 120 mg or more and 250 mg or less.

The surface area of the flavor source 40 (the surface area of the flavor source 40 contributing to aerosol generation) is preferably 150 mm² or more and 4000 mm² or less. The second portion of the flavor source 40 may be composed of strand-like tobacco leaves. In this case, the width of the strand-like tobacco leaves is preferably 1 mm or less, more preferably 0.5 mm or less.

The first and second portions of the flavor source 40 may carry a fragrance. The type of fragrance is not particularly limited, but from the standpoint of imparting a good fragrance sensation, at least one of acetylanisole, acetophenone, acetylpyrazine, 2-acetylthiazole, alfalfa extract, amyl alcohol, amyl butyrate, trans-anethole, star anise oil, apple juice, Peru balsam oil, beeswax absolute, benzaldehyde, benzoin resinoid, benzyl alcohol, benzyl benzoate, benzyl phenylacetate, benzyl propionate, 2,3-butanedione, 2-butanol, butyl butyrate, butyric acid, caramel, cardamom oil, carob absolute, β-carotene, carrot juice, L-carvone, β-caryophyllene, cassia bark oil, cedarwood oil, celery seed oil, chamomile oil, cinnamaldehyde, cinnamic acid, cinnamyl alcohol, cinnamyl cinnamate, citronella oil, DL-citronellol, clary sage extract, cocoa, coffee, cognac oil, coriander oil, cumin aldehyde, davana oil, δ-decalactone, γ-decalactone, decanoic acid, dill herb oil, 3,4-dimethyl-1,2-cyclopentanedione, 4,5-dimethyl-3-hydroxy-2,5-dihydrofuran-2-one, 3,7-dimethyl-6-octenoic acid, 2,3-dimethylpyrazine, 2,5-dimethylpyrazine, 2,6-dimethylpyrazine, 2-methylbutyric acid ethyl ester, ethyl acetate, ethyl butyrate, ethyl hexanoate, ethyl isovalerate, ethyl lactate, ethyl laurate, ethyl levulinate, ethyl maltol, ethyl octanoate, ethyl oleate, ethyl palmitate, ethyl phenylacetate, ethyl propionate, ethyl stearate, ethyl valerate, ethyl vanillin, ethyl vanillin glucoside, 2-ethyl-3,(5 or 6)-dimethylpyrazine, 5-ethyl-3-hydroxy-4-methyl-2(5H)-furanone, 2-ethyl-3-methylpyrazine, eucalyptol, fenugreek absolute, genet absolute, gentian root infusion, geraniol, geranyl acetate, grape juice, guaiacol, guava extract, γ-heptalactone, γ-hexalactone, hexanoic acid, cis-3-hexen-1-ol, hexyl acetate, hexyl alcohol, hexyl phenylacetate, honey, 4-hydroxy-3-pentenoic acid lactone, 4-hydroxy-4-(3-hydroxy-1-butenyl)-3,5,5-trimethyl-2-cyclohexen-1-one, 4-(para-hydroxyphenyl)-2-butanone, 4-hydroxyundecanoic acid sodium salt, immortelle absolute, β-ionone, isoamyl acetate, isoamyl butyrate, isoamyl phenylacetate, isobutyl acetate, isobutyl phenylacetate, jasmine absolute, kola nut tincture, labdanum oil, lemon terpeneless oil, licorice extract, linalool, linalyl acetate, lovage root oil, maltol, maple syrup, menthol, menthone, L-menthyl acetate, para-methoxybenzaldehyde, methyl-2-pyrrolyl ketone, methyl anthranilate, methyl phenylacetate, methyl salicylate, 4′-methylacetophenone, methylcyclopentenolone, 3-methylvaleric acid, mimosa absolute, molasses, myristic acid, nerol, nerolidol, γ-nonalactone, nutmeg oil, δ-octalactone, octanal, octanoic acid, orange flower oil, orange oil, orris root oil, palmitic acid, ω-pentadecalactone, peppermint oil, petitgrain Paraguay oil, phenethyl alcohol, phenethyl phenylacetate, phenylacetic acid, piperonal, plum extract, propenyl guaiacol, propyl acetate, 3-propylidenephthalide, prune juice, pyruvic acid, raisin extract, rose oil, rum, sage oil, sandalwood oil, spearmint oil, styrax absolute, marigold oil, tea distillate, α-terpineol, terpinyl acetate, 5,6,7,8-tetrahydroquinoxaline, 1,5,5,9-tetramethyl-13-oxacyclo(8.3.0.0(4.9))tridecane, 2,3,5,6-tetramethylpyrazine, thyme oil, tomato extract, 2-tridecanone, triethyl citrate, 4-(2,6,6-trimethyl-1-cyclohexenyl)2-buten-4-one, 2,6,6-trimethyl-2-cyclohexene-1,4-dione, 4-(2,6,6-trimethyl-1,3-cyclohexadienyl)2-buten-4-one, 2,3,5-trimethylpyrazine, γ-undecalactone, γ-valerolactone, vanilla extract, vanillin, veratraldehyde, violet leaf absolute, N-ethyl-p-menthane-3-carboxamide (WS-3), ethyl-2-(p-menthane-3-carboxamido)acetate (WS-5), sugars (sucrose, fructose, etc.), cocoa powder, carob powder, coriander powder, licorice powder, orange peel powder, rosehip powder, chamomile flower powder, lemon verbena powder, peppermint powder, leaf powder, spearmint powder, tea powder, natural plant-based fragrances (e.g., jasmine oil, lemon oil, vetiver oil, lovage oil), and esters may be selected.

The flavor source 40 may be provided with a hollow section 41, into which the pin-type antenna 106 can be inserted, extending through the longitudinal direction of the flavor source 40. The diameter of the hollow section 41 may be larger than or the same as the antenna diameter. If the flavor source 40 does not have a hollow section 41, components of the heated flavor source 40 may adhere to the pin-type antenna 106 when it is inserted. By inserting the pin-type antenna 106 into the hollow section 41 of the flavor source 40, the flavor source 40 does not adhere closely to the pin-type antenna 106. Therefore, it is possible to suppress the adhesion of components of the heated flavor source 40 to the pin-type antenna 106.

Additionally, the inside of the flavor source 40 may have elements such as a paper layer to prevent direct contact between the flavor source 40 and the pin-type antenna 106. This element may be porous or have multiple holes. An air passage through the hollow section 41 may also be formed between the flavor source 40 and the pin-type antenna 106.

The support element 50 is positioned in contact with the flavor source 40 between the flavor source 40 and the cooling element 60. The support element 50 can be made of synthetic fibers such as cellulose acetate tow. The support element 50 prevents the flavor source 40 from being pushed toward the downstream side of the flavor generating article 20 when the pin-type antenna 106 is inserted into the flavor source 40.

The support element 50 may also be provided with an opening 51 that penetrates in the longitudinal direction to avoid filtering the flavor or aerosol generated by the flavor source 40. The diameter of the opening 51 may be larger than the diameter of the hollow section 41 of the flavor source 40. Instead of providing the opening 51 in the center of the support element 50, multiple holes or grooves penetrating in the longitudinal direction may be provided on the side or near the outer edge of the support element 50. The length of the support element 50 may be longer than the length of the flavor source 40. The tip of the pin-type antenna 106 does not need to reach inside the opening 51 of the support element 50.

The cooling element 60 is positioned downstream of the support element 50. The cooling element 60 may be a paper tube or the like, for example. The cooling element 60 cools the flavor or aerosol generated by the flavor source 40. Inside the cooling element 60, materials such as sheets may be filled to increase the contact area with the flavor or aerosol and promote cooling of the flavor or aerosol.

Additionally, multiple through-holes 61 passing through the wall surface concentrically with the circumferential direction of the cooling element 60 may be formed in the cooling element 60. The through-holes 61 facilitate the inflow of air from the outside due to the user's inhalation, further cooling the flavor or aerosol generated by the flavor source 40 by the inflow of air. Multiple through-holes may also be formed in the support element 50, flavor source 40, and plug element 30.

The cooling element 60 may also be provided with an opening 62 that penetrates in the longitudinal direction of the cooling element 60. The diameter of the opening 62 may be larger than the diameter of the opening 51 of the support element 50. The length of the cooling element 60 may be shorter than the length of the support element 50. The hollow section 41 of the flavor source 40, the opening 51 of the support element 50, and the opening 62 of the cooling element 60 may be arranged to have the same axis.

The filter element 70 is positioned downstream of the cooling element 60. The filter element 70 can use synthetic fibers such as cellulose acetate tow, for example, as a material. The filter element 70 is not particularly limited as long as it has the general function of a filter. The general functions of a filter include, for example, adjusting the amount of air mixed during aerosol inhalation, reducing flavor, and reducing nicotine and tar, but it is not necessary to have all these functions.

When the flavor generating article 20 is positioned at a desired position in the flavor inhaler 100, the cooling element 60 and filter element 70 may be exposed outside the flavor inhaler 100. If the through-holes 61 are formed in the cooling element 60, the through-holes 61 may be exposed outside the flavor inhaler 100 when the flavor generating article 20 is positioned at a desired position in the flavor inhaler 100.

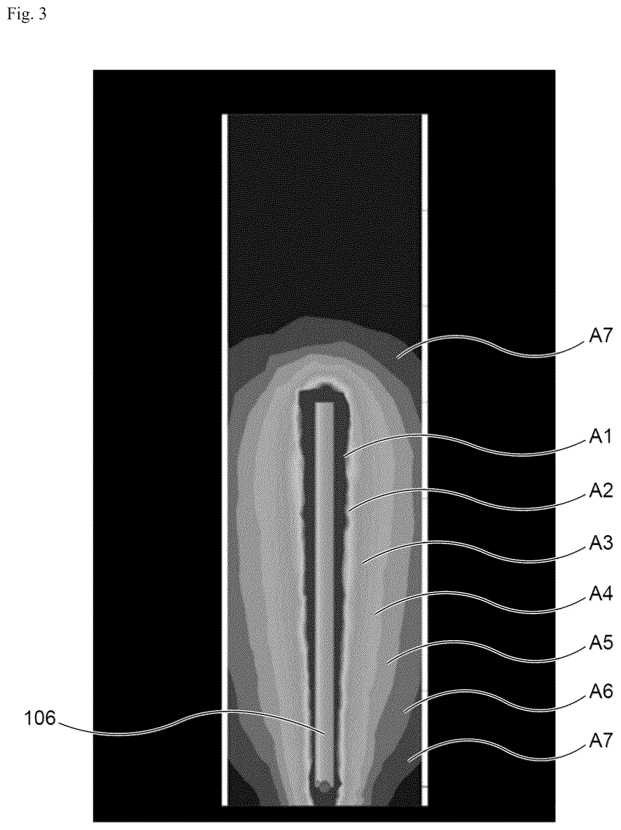

Here, the pin-type antenna 106 shown in FIG. 1 exhibits a characteristic electric field intensity distribution. FIG. 3 is a schematic diagram representing the electric field intensity distribution of microwaves emitted from the pin-type antenna shown in FIG. 1. This electric field intensity distribution shows the simulation results of the electric field intensity when a pin-type antenna 106 with a diameter of 1.0 mm and a length of 20 mm is placed at the center of a copper pipe with an inner diameter of about 10 mm and a thickness of about 0.5 mm. For simplification of the simulation, the inside of the copper pipe is filled with air.

As shown in FIG. 3, the electric field intensity distribution of microwaves emitted from the pin-type antenna 106 is shown in regions A1 to A7, with region A1 having the strongest electric field intensity, and the electric field intensity decreasing in the order of region A1, region A2, region A3, region A4, region A5, region A6, and region A7.

From FIG. 3, it can be seen that the electric field intensity of microwaves emitted from the pin-type antenna 106 is strong in the region near the tip of the antenna and weak in the region near the base end of the antenna. Additionally, from FIG. 3, it can be seen that the electric field intensity of microwaves emitted from the pin-type antenna 106 is strong in the region close to the antenna in the direction orthogonal to the longitudinal direction and weak in the region far from the antenna.

Therefore, it is preferable that the tip of the pin-type antenna 106 is arranged to overlap with the flavor source 40 in the longitudinal direction when the flavor generating article 20 is positioned at a desired position in the flavor inhaler 100. By arranging the tip of the pin-type antenna 106 with strong electric field intensity to overlap with the flavor source 40 in the longitudinal direction, it is possible to efficiently transmit microwaves emitted from the pin-type antenna 106 to the flavor source 40.

Even when an antenna other than the pin-type antenna 106 is used, it can be said that the electric field intensity of microwaves emitted from the antenna is strong in the region close to the antenna in the direction orthogonal to the longitudinal direction and weak in the region far from the antenna.

Additionally, by changing the arrangement of the first portion and the second portion in the flavor source 40 according to the electric field intensity distribution of microwaves emitted from the pin-type antenna 106, it is possible to prevent the carbonization of carbonizable substances contained in the second portion by microwave heating.

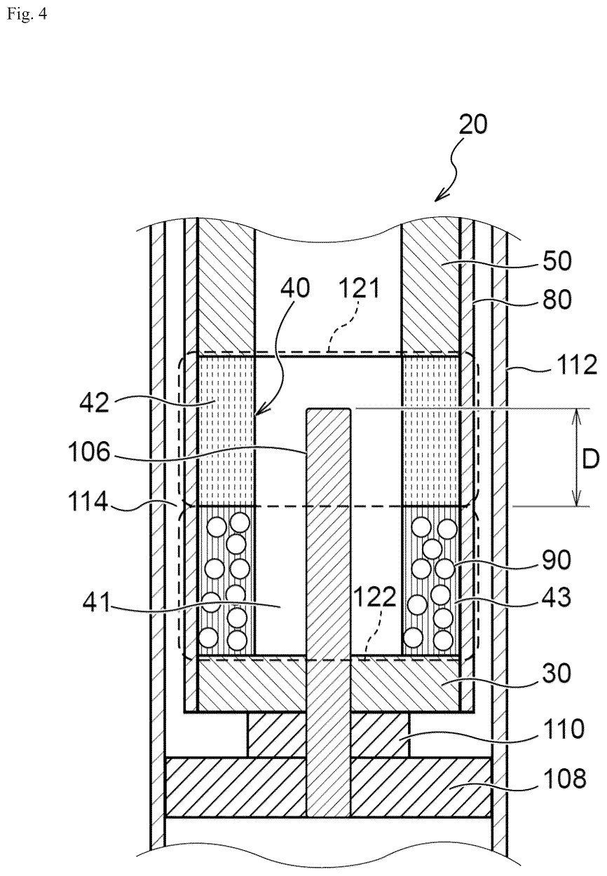

FIG. 4 is an enlarged sectional view showing a part of the flavor inhalation system shown in FIG. 1. Specifically, it shows the flavor source 40, pin-type antenna 106, housing 112, and chamber 114 when the flavor generating article 20 is positioned at a desired position in the flavor inhaler 100.

As shown in FIG. 4, a first region 121 including the region near the tip of the pin-type antenna 106 where the electric field intensity of microwaves emitted from the pin-type antenna 106 is strongest, and a second region 122 near the base end of the pin-type antenna 106 where the electric field intensity is weaker than in the first region 121, are formed within the chamber 114.

Here, in the flavor source 40, the first portion 42 containing an aerosol generating substance that generates aerosol when heated is arranged corresponding to the first region 121, and the second portion 43 containing a flavor generating substance that generates flavor when heated is arranged corresponding to the second region 122. As described above, the first portion 42 does not contain carbonizable substances, and the second portion 43 contains carbonizable substances.

By including carbonizable substances that easily carbonize upon heating in the second portion 43 corresponding to the second region 122 near the base end of the pin-type antenna 106, where the electric field intensity is weaker than in the first region 121 near the tip of the pin-type antenna 106, it is possible to prevent the carbonization of carbonizable substances by microwave heating. Therefore, it is possible to prevent the carbonization of substances contained in the flavor source 40.

The second portion 43 may include a microwave absorber 90 that absorbs microwaves and generates heat. By including a microwave absorber in the second portion 43, it is possible to efficiently heat the second portion 43.

Additionally, the distance D between the tip of the pin-type antenna 106 and the second portion 43 in the longitudinal direction is preferably 0.1 mm or more. By setting the distance D between the tip of the pin-type antenna 106 and the second portion 43 in the longitudinal direction to 0.1 mm or more, it is possible to further prevent the carbonization of carbonizable substances by microwave heating.

Additionally, the distance D between the tip of the pin-type antenna 106 and the second portion 43 in the longitudinal direction may be 0.5 mm or more. By setting the distance D between the tip of the pin-type antenna 106 and the second portion 43 in the longitudinal direction to 0.5 mm or more, it is possible to prevent the second portion 43 from approaching the pin-type antenna 106 too closely even if the user strongly inserts the flavor generating article 20 into the flavor inhaler 100.

Additionally, the distance D between the tip of the pin-type antenna 106 and the second portion 43 in the longitudinal direction is preferably 3.0 mm or less. If the distance D between the tip of the pin-type antenna 106 and the second portion 43 in the longitudinal direction exceeds 3.0 mm, the second portion 43 may become too far from the pin-type antenna 106, and the heating of the second portion 43 may not be promoted.

In the flavor generating article 20 using the flavor source 40 with the arrangement of the first portion 42 and the second portion 43 shown in FIG. 4, air flowing in from the plug element 30 of the flavor generating article 20 passes through the interior and/or hollow section 41 of the flavor source 40, is mixed with the flavor or aerosol, passes through the support element 50, is cooled by the cooling element 60, and then passes through the filter element 70 to reach the user's mouth.

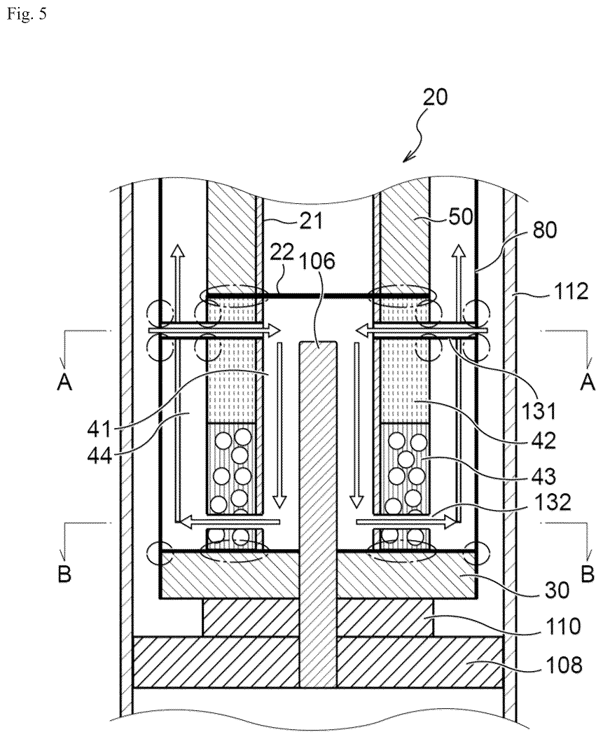

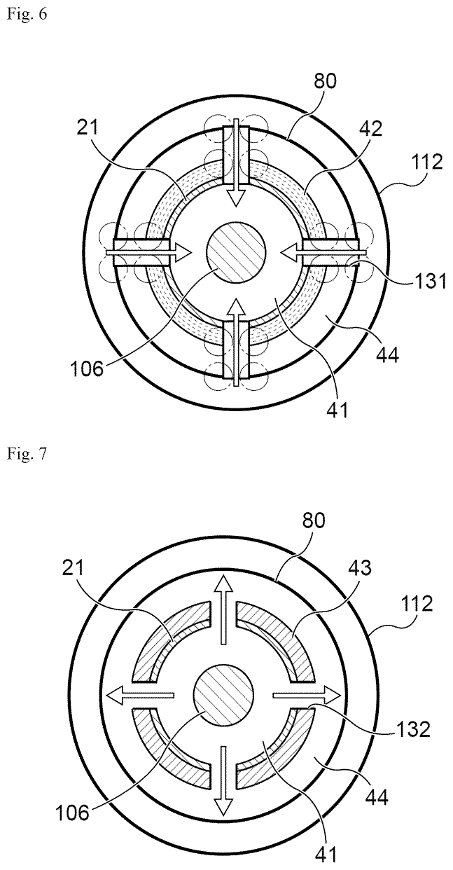

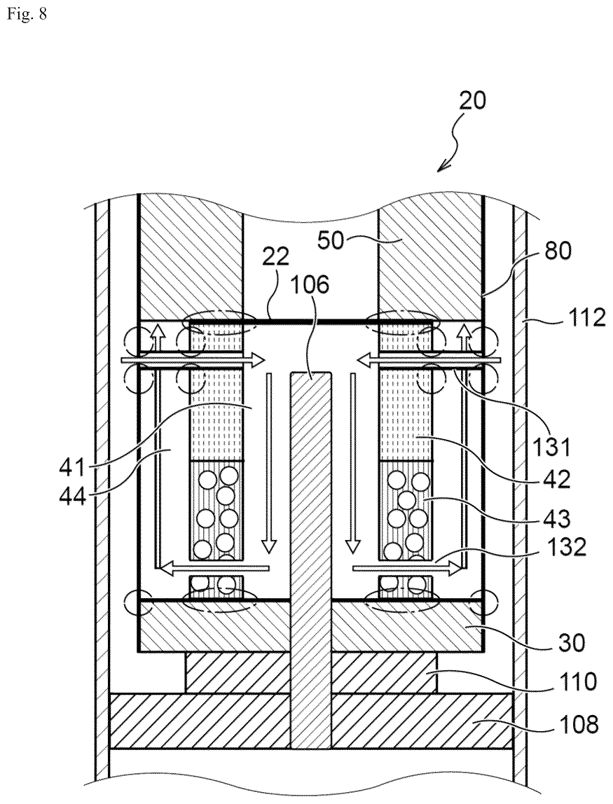

Next, another airflow in the flavor generating article 20 of air flowing in from the exterior of the flavor generating article 20 to the user's mouth will be described with reference to FIG. 5. FIG. 5 is a schematic diagram showing the flow of air in the flavor generating article 20. In FIG. 5, the arrangement of the first portion 42 and the second portion 43 in the flavor source 40 is the same as that shown in FIG. 4. FIG. 6 is a sectional view of the flavor source along A-A shown in FIG. 5. FIG. 7 is a sectional view of the flavor source along B-B shown in FIG. 5.

As shown in FIGS. 5 to 7, the outer periphery of the flavor source 40 is surrounded by the tip paper (outer member) 80, and a gap 44 is formed between the flavor source 40 and the tip paper 80. The flavor generating article 20 may include a tubular element 21. The tubular element 21 may be in contact with the inner surface of the flavor source 40 (the inner surfaces of the first portion 42 and the second portion 43). Additionally, the tubular element 21 may cover at least part or all of the inner surface of the flavor source 40 (the inner surfaces of the first portion 42 and the second portion 43). The tubular element 21 may hold the flavor source 40.

The tubular element 21 may extend over the flavor source 40 and the support element 50. In this case, the support element 50 may be fixed to the tip paper (outer member) 80 or the filter element 70, and the flavor source 40 may be held by the support element 50 via the tubular element 21. The tubular element 21 may be gas-permeable to allow components of the heated flavor source 40 to flow into the hollow section 41.

A sealing section 22 may be provided between the flavor source 40 and the support element 50. The sealing section 22 may seal between the flavor source 40 and the support element 50 to prevent air from flowing from the flavor source 40 or the hollow section 41 to the support element 50. Additionally, to prevent components of the heated flavor source 40 from adhering to the pin-type antenna 106, elements such as a paper layer may be provided between the tubular element 21 and the pin-type antenna 106.

Additionally, a first air passage 131 is formed in the tip paper 80 and the first portion 42 to communicate and seal the exterior of the flavor generating article 20 with the hollow section 41. A second air passage 132 is formed in the second portion 43 to communicate the hollow section 41 with the gap 44. Here, the outer periphery of the flavor source 40 may be surrounded by the tip paper 80 and the wrapper (outer member).

As shown in FIG. 8, the tip paper (outer member) 80 and the support element 50 may be in contact. In this case, the support element 50 may be joined to the tip paper (outer member) 80. The flavor source 40 may be supported by the support element 50 via the sealing section 22. For example, the downstream end of the flavor source 40 may be joined to the sealing section 22 with adhesive or the like, and the upstream end of the support element 50 may be joined to the sealing section 22 with adhesive or the like. With such a structure, the flavor generating article 20 can hold the flavor source 40 inside even without the tubular element 21. The support element 50 may have multiple holes or grooves penetrating in the longitudinal direction on the side or near the outer edge of the support element 50.

The tip paper (outer member) 80 and the support element 50 may be in contact, and the flavor generating article 20 may include the tubular element 21. The tubular element 21 may be supported by the plug element 30 and the support element 50. In this case, since the tubular element 21 is supported at two points by the plug element 30 and the support element 50, the wobbling of the tubular element 21 can be suppressed. Additionally, even if the flavor generating article 20 is inserted into the flavor inhaler 100 with the flavor generating article 20 in a tilted state relative to the pin-type antenna 106, the tubular element 21 can function as a protective layer, preventing damage to the flavor source 40, support element 50, the tip paper (outer member) 80, etc., by the pin-type antenna 106.

Here, the first air passage 131 can be formed by inserting a tubular member like a straw to penetrate the tip paper 80 and the first portion 42. The second air passage 132 can be appropriately formed by known hole-making methods. Additionally, the proximal end side (downstream side) of the flavor source 40 is sealed in the longitudinal direction except for the gap 44, and the distal end side (upstream side) of the flavor source 40 is sealed in the longitudinal direction.

The sealed portions of the flavor generating article 20 are indicated by the dotted lines in FIGS. 5 and 6. This forms an air passage where air flowing in from the exterior of the flavor generating article 20 passes through the first air passage 131, the hollow section 41, the second air passage 132, and the gap 44 in sequence. Note that the flavor source 40 may be fixed to the plug element 30 shown in FIG. 2 by adhesion or the like for example, or positioned relative to the tip paper 80 by the tubular member.

As shown by the arrows in FIGS. 5 to 8, air flowing in from the exterior of the flavor generating article 20 passes through the first air passage 131, the hollow section 41, the second air passage 132, and the gap 44 in sequence, passes through the support element 50, is cooled by the cooling element 60, and then passes through the filter element 70 to reach the user's mouth.

At this time, the air flowing in from the exterior of the flavor generating article 20 first flows along the first portion 42 and mixes with the aerosol generated in the first portion 42, then flows along the second portion 43 and mixes with the flavor generated in the second portion 43. Therefore, it is possible to efficiently mix the flavor generated in the second portion 43 with the aerosol generated in the first portion 42.

Note that the first air passage only needs to communicate and seal the exterior of the flavor generating article 20 with at least the first portion 42, and the second air passage only needs to communicate at least the second portion 43 with the gap 44. Even in this case, an air passage is formed where air flowing in from the exterior of the flavor generating article 20 passes through the first air passage, the first portion 42, the second portion 43, the second air passage, and the gap 44 in sequence, so it is possible to efficiently mix the flavor generated in the second portion 43 with the aerosol generated in the first portion 42.

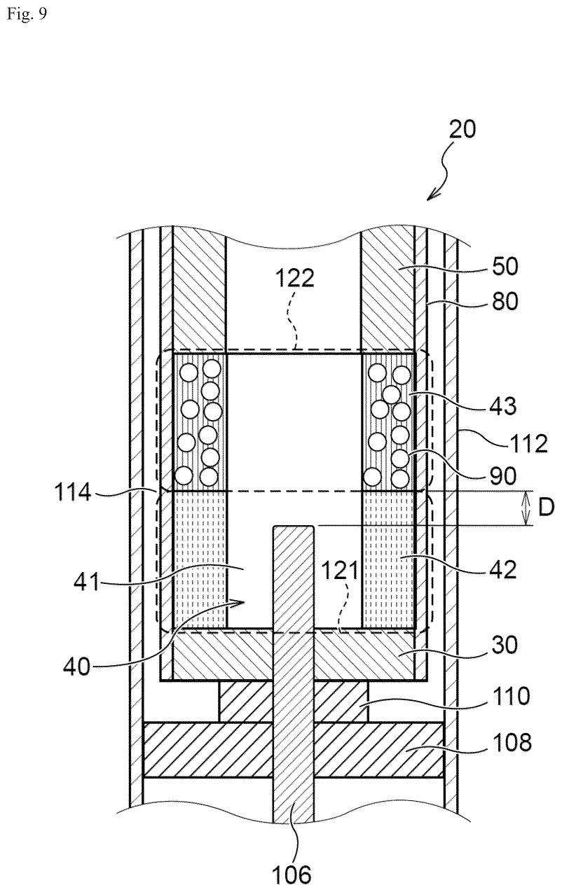

FIG. 9 is another enlarged sectional view showing a part of the flavor inhalation system shown in FIG. 1. Specifically, it shows the flavor source 40, pin-type antenna 106, housing 112, and chamber 114 when the flavor generating article 20 is positioned at a desired position in the flavor inhaler 100.

As shown in FIG. 9, a first region 121 including the region near the tip of the pin-type antenna 106 where the electric field intensity of microwaves emitted from the pin-type antenna 106 is strongest, and a second region 122 on the opposite side of the base end of the pin-type antenna 106 relative to the tip, where the electric field intensity is weaker than in the first region 121, are formed within the chamber 114.

Here, in the flavor source 40, the first portion 42 containing an aerosol generating substance that generates aerosol when heated is arranged corresponding to the first region 121, and the second portion 43 containing a flavor generating substance that generates flavor when heated is arranged corresponding to the second region 122. As described above, the first portion 42 does not contain carbonizable substances, and the second portion 43 contains carbonizable substances.

By including carbonizable substances that easily carbonize upon heating in the second portion 43 corresponding to the second region 122 on the opposite side of the base end of the pin-type antenna 106 relative to the tip, where the electric field intensity is weaker than in the first region 121 near the tip of the pin-type antenna 106, it is possible to prevent the carbonization of carbonizable substances by microwave heating. Therefore, it is possible to prevent the carbonization of substances contained in the flavor source 40.

To adjust the positions of the first portion 42 and the second portion 43 relative to the pin-type antenna 106, the length of the pin-type antenna 106 may be adjusted, or the plug element 30 shown in FIG. 2 may be arranged on the base end side of the pin-type antenna 106 in the flavor source 40. Additionally, the second portion 43 may include a microwave absorber 90 that absorbs microwaves and generates heat. By including a microwave absorber in the second portion 43, it is possible to efficiently heat the second portion 43.

Additionally, the distance D between the tip of the pin-type antenna 106 and the second portion 43 in the longitudinal direction is preferably 0.1 mm or more. By setting the distance D between the tip of the pin-type antenna 106 and the second portion 43 in the longitudinal direction to 0.1 mm or more, it is possible to further prevent the carbonization of carbonizable substances by microwave heating. By setting the distance D between the tip of the pin-type antenna 106 and the second portion 43 in the longitudinal direction to 0.5 mm or more and is preferably 3.0 mm or less, it is possible to further prevent the carbonization of carbonizable substances by microwave heating.

In the flavor generating article 20 using the flavor source 40 with the arrangement of the first portion 42 and the second portion 43 shown in FIG. 9, air flowing in from the plug element 30 of the flavor generating article 20 passes through the interior and/or hollow section 41 of the flavor source 40, is mixed with the flavor or aerosol, passes through the support element 50, is cooled by the cooling element 60, and then passes through the filter element 70 to reach the user's mouth.

At this time, the air flowing in from the plug element 30 of the flavor generating article 20 first flows along the first portion 42 and mixes with the aerosol generated in the first portion 42, then flows along the second portion 43 and mixes with the flavor generated in the second portion 43. Therefore, it is possible to efficiently mix the flavor generated in the second portion 43 with the aerosol generated in the first portion 42.

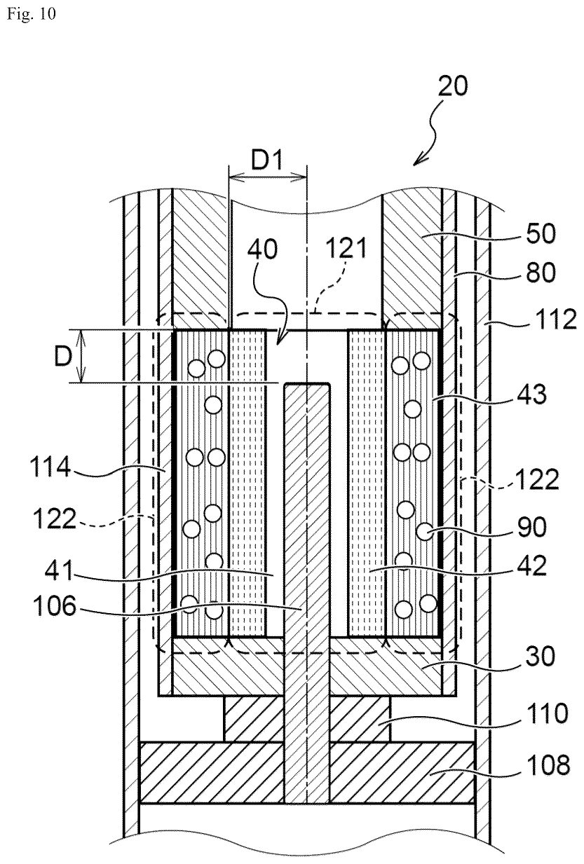

FIG. 10 is yet another enlarged sectional view showing a part of the flavor inhalation system shown in FIG. 1. Specifically, it shows the flavor source 40, pin-type antenna 106, housing 112, and chamber 114 when the flavor generating article 20 is positioned at a desired position in the flavor inhaler 100.

As shown in FIG. 10, within the chamber 114, a first region 121 including the region close to the pin-type antenna 106 in the direction orthogonal to the longitudinal direction, where the electric field intensity of microwaves emitted from the pin-type antenna 106 is strongest, and a second region 122 far from the pin-type antenna 106 in the direction orthogonal to the longitudinal direction, where the electric field intensity is weaker than in the first region 121, are formed.

Here, in the flavor source 40, the first portion 42 containing an aerosol generating substance that generates aerosol when heated is arranged corresponding to the first region 121, and the second portion 43 containing a flavor generating substance that generates flavor when heated is arranged corresponding to the second region 122. As described above, the first portion 42 does not contain carbonizable substances, and the second portion 43 contains carbonizable substances.

By including carbonizable substances that easily carbonize upon heating in the second portion 43 corresponding to the second region 122 far from the pin-type antenna 106, where the electric field intensity is weaker than in the first region 121 close to the pin-type antenna 106, it is possible to prevent the carbonization of carbonizable substances by microwave heating. Therefore, it is possible to prevent the carbonization of substances contained in the flavor source 40.

The second portion 43 may include a microwave absorber 90 that absorbs microwaves and generates heat. By including a microwave absorber in the second portion 43, it is possible to efficiently heat the second portion 43.

Additionally, the distance D between the tip of the pin-type antenna 106 and the second portion 43 in the longitudinal direction is preferably 0.1 mm or more. By setting the distance D between the tip of the pin-type antenna 106 and the second portion 43 in the longitudinal direction to 0.1 mm or more, it is possible to further prevent the carbonization of carbonizable substances by microwave heating. By setting the distance D between the tip of the pin-type antenna 106 and the second portion 43 in the longitudinal direction to 0.5 mm or more and is preferably 3.0 mm or less, it is possible to further prevent the carbonization of carbonizable substances by microwave heating.

Additionally, the distance D1 between the center of the pin-type antenna 106 and the second portion 43 in the radial direction is preferably 0.1 mm or more. By setting the distance D1 between the center of the pin-type antenna 106 and the second portion 43 in the radial direction to 0.1 mm or more, it is possible to further prevent the carbonization of carbonizable substances by microwave heating. Additionally, the distance D1 between the center of the pin-type antenna 106 and the second portion 43 in the radial direction may be 0.5 mm or more and is preferably 3.0 mm or less.

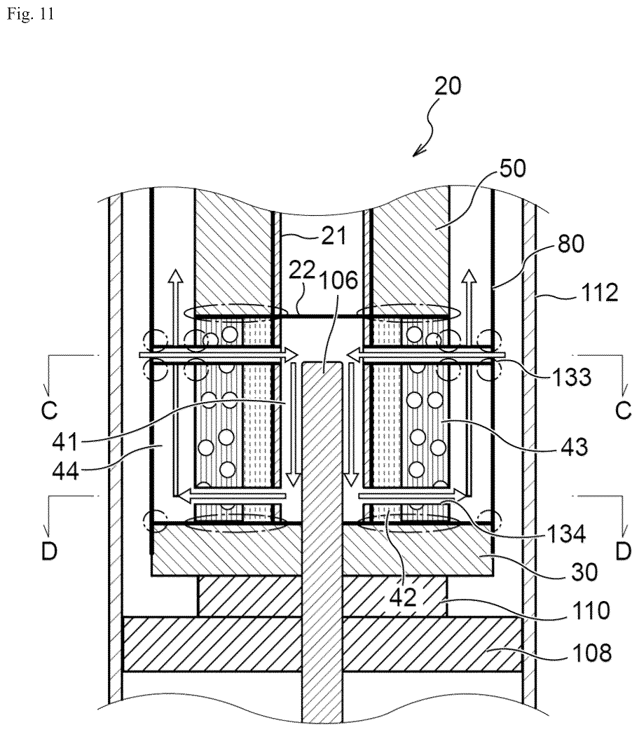

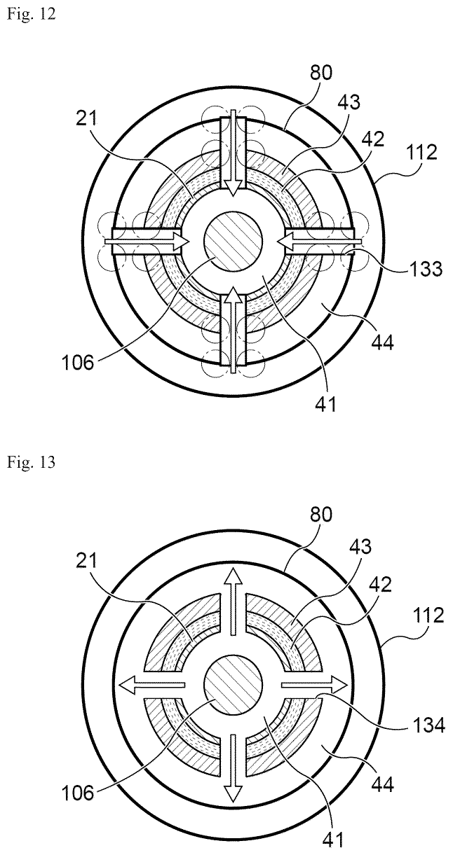

Next, another airflow in the flavor generating article 20 of air flowing in from the exterior of the flavor generating article 20 to the user's mouth will be described with reference to FIG. 11. FIG. 11 is yet another schematic diagram showing the flow of air in the flavor generating article 20. In FIG. 11, the arrangement of the first portion 42 and the second portion 43 in the flavor source 40 is the same as that shown in FIG. 10. FIG. 12 is a sectional view of the flavor source along C-C shown in FIG. 11. FIG. 13 is a sectional view of the flavor source along D-D shown in FIG. 11.

As shown in FIGS. 11 to 13, the outer periphery of the flavor source 40 is surrounded by the tip paper (outer member) 80, and a gap 44 is formed between the flavor source 40 and the tip paper 80. The flavor generating article 20 may include a tubular element 21. The tubular element 21 may be in contact with the inner surface of the flavor source 40 (the inner surfaces of the first portion 42 and the second portion 43). Additionally, the tubular element 21 may cover at least part or all of the inner surface of the flavor source 40 (the inner surfaces of the first portion 42 and the second portion 43). The tubular element 21 may hold the flavor source 40.

The tubular element 21 may extend over the flavor source 40 and the support element 50. In this case, the support element 50 may be fixed to the tip paper (outer member) 80 or the filter element 70, and the flavor source 40 may be held by the support element 50 via the tubular element 21. The tubular element 21 may be gas-permeable to allow components of the heated flavor source 40 to flow into the hollow section 41.

A sealing section 22 may be provided between the flavor source 40 and the support element 50. The sealing section 22 may seal between the flavor source 40 and the support element 50 to prevent air from flowing from the flavor source 40 or the hollow section 41 to the support element 50. Additionally, to prevent components of the heated flavor source 40 from adhering to the pin-type antenna 106, elements such as a paper layer may be provided between the tubular element 21 and the pin-type antenna 106.

Additionally, a third air passage 133 is formed in the tip paper 80, the first portion 42, and the second portion 43 on the proximal end side (downstream side) of the flavor generating article 20 to communicate and seal the exterior of the flavor generating article 20 with the hollow section 41. A fourth air passage 134 is formed in the first portion 42 and the second portion 43 on the distal end side (upstream side) of the flavor generating article 20 to communicate the hollow section 41 with the gap 44. Here, the outer periphery of the flavor source 40 may be surrounded by the tip paper 80 and the wrapper (outer member).

As described in FIG. 8, the tip paper (outer member) 80 and the support element 50 may be in contact. In this case, the support element 50 may be joined to the tip paper (outer member) 80. The flavor source 40 may be supported by the support element 50 via the sealing section 22. For example, the downstream end of the flavor source 40 may be joined to the sealing section 22 with adhesive or the like, and the upstream end of the support element 50 may be joined to the sealing section 22 with adhesive or the like. With such a structure, the flavor generating article 20 can hold the flavor source 40 inside even without the tubular element 21. The support element 50 may have multiple holes or grooves penetrating in the longitudinal direction on the side or near the outer edge of the support element 50.

The tip paper (outer member) 80 and the support element 50 may be in contact, and the flavor generating article 20 may include the tubular element 21. The tubular element 21 may be supported by the plug element 30 and the support element 50. In this case, since the tubular element 21 is supported at two points by the plug element 30 and the support element 50, the wobbling of the tubular element 21 can be suppressed. Additionally, even if the flavor generating article 20 is inserted into the flavor inhaler 100 with the flavor generating article 20 in a tilted state relative to the pin-type antenna 106, the tubular element 21 can function as a protective layer, preventing damage to the flavor source 40, support element 50, the tip paper (outer member) 80, etc., by the pin-type antenna 106.

Here, the third air passage 133 can be formed by inserting a tubular member like a straw to penetrate the tip paper 80, the first portion 42, and the second portion 43. The fourth air passage 134 can be appropriately formed by known hole-making methods. Additionally, the proximal end side (downstream side) of the flavor source 40 is sealed in the longitudinal direction except for the gap 44, and the distal end side (upstream side) of the flavor source 40 is sealed in the longitudinal direction.

The sealed portions of the flavor generating article 20 are indicated by the dotted lines in FIGS. 12 and 13. This forms an air passage where air flowing in from the exterior of the flavor generating article 20 passes through the third air passage 133, hollow section 41, fourth air passage 134, and gap 44 in sequence. Note that the flavor source 40 may be fixed to the plug element 30 shown in FIG. 2 by adhesion or the like for example, or positioned relative to the tip paper 80 by the tubular member.

As shown by the arrows in FIGS. 11 to 13, air flowing in from the exterior of the flavor generating article 20 passes through the third air passage 133, hollow section 41, fourth air passage 134, and gap 44 in sequence, passes through the support element 50, is cooled by the cooling element 60, and then passes through the filter element 70 to reach the user's mouth.

At this time, the air flowing in from the exterior of the flavor generating article 20 first flows along the first portion 42 and mixes with the aerosol generated in the first portion 42, then flows along the second portion 43 and mixes with the flavor generated in the second portion 43. Therefore, it is possible to efficiently mix the flavor generated in the second portion 43 with the aerosol generated in the first portion 42.

Note that the third air passage only needs to communicate and seal the exterior of the flavor generating article 20 with at least the first portion 42, and the second air passage only needs to communicate at least the second portion 43 with the gap 44. Even in this case, an air passage is formed where air flowing in from the exterior of the flavor generating article 20 passes through the third air passage, first portion 42, second portion 43, fourth air passage, and gap 44 in sequence, so it is possible to efficiently mix the flavor generated in the second portion 43 with the aerosol generated in the first portion 42.

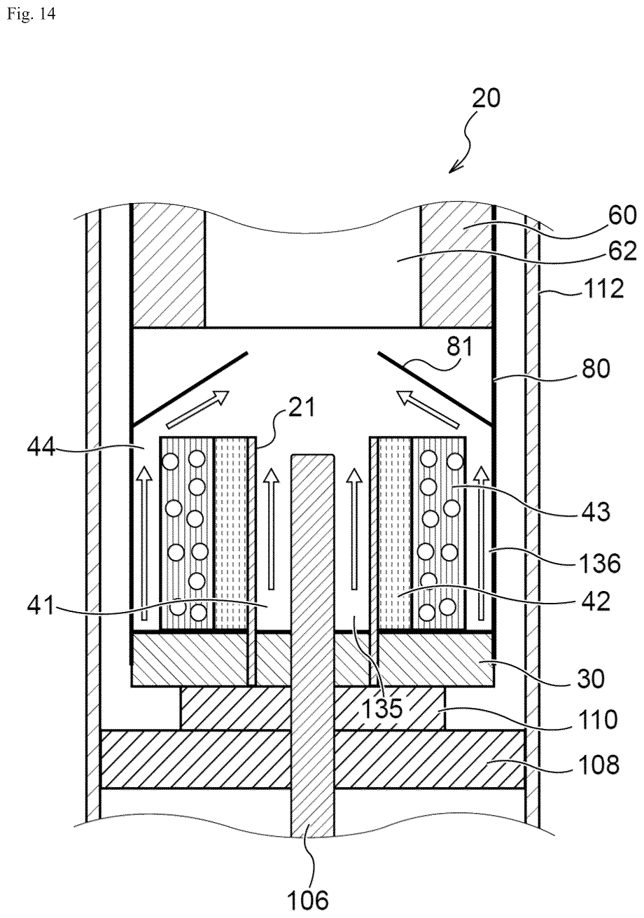

Next, another airflow from the exterior of the flavor generating article 20 to the user's mouth will be described with reference to FIG. 14. FIG. 14 is yet another schematic diagram showing the flow of air in the flavor generating article 20. In FIG. 14, the arrangement of the first portion 42 and the second portion 43 in the flavor source 40 is the same as that shown in FIG. 10.

As shown in FIG. 14, the outer periphery of the flavor source 40 is surrounded by tip paper (outer member) 80, and a gap 44 is formed between the flavor source 40 and the tip paper 80. The flavor generating article 20 may include a tubular element 21. The tubular element 21 may be in contact with the inner surface of the flavor source 40 (the inner surfaces of the first portion 42 and the second portion 43). Additionally, the tubular element 21 may cover at least part or all of the inner surface of the flavor source 40 (the inner surfaces of the first portion 42 and the second portion 43). The tubular element 21 may hold the flavor source 40.

The tubular element 21 may be fixed to the plug element 30. In this case, the flavor generating article 20 may not need to have the support element 50. The tubular element 21 may be gas-permeable to allow components of the heated flavor source 40 to flow into the hollow section 41. Additionally, to prevent components of the heated flavor source 40 from adhering to the pin-type antenna 106, elements such as a paper layer may be provided between the tubular element 21 and the pin-type antenna 106.

Additionally, a fifth air passage 135 is formed in the hollow section 41, and a sixth air passage 136, which has a smaller flow path area than the fifth air passage 135 and merges with the fifth air passage 135 before reaching the proximal end of the flavor generating article 20, is formed in the gap 44. Additionally, the tip paper 80 may be provided with a guide member 81 that directs the air passing through the sixth air passage 136 toward the hollow section 41. The guide member 81 may be formed of the same material as the tip paper 80. Here, the outer periphery of the flavor source 40 may be surrounded by the tip paper 80 and the wrapper (outer member).

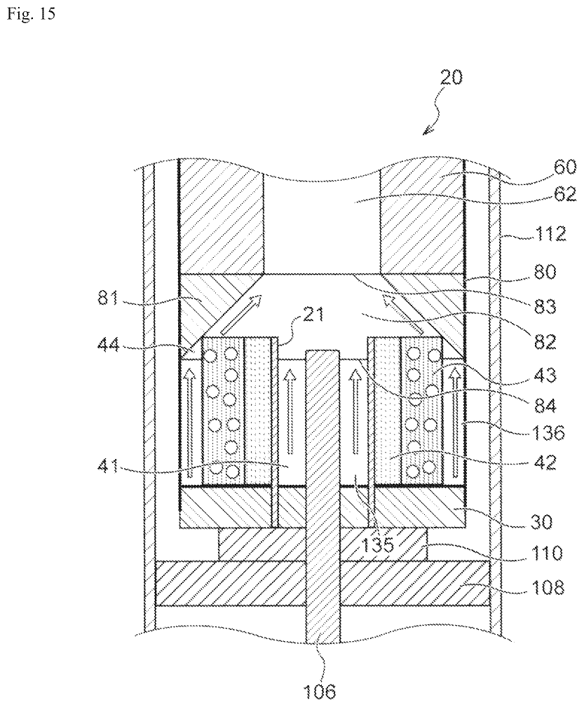

As shown in FIG. 15, the guide member 81 is a hollow element with a hollow section 82 extending along its longitudinal direction, and the opening 84 of the guide member 81 at the upstream end may be larger than the opening 83 of the guide member 81 at the downstream end. In this case, the hollow section 82 may gradually reduce in diameter toward the downstream side. The hollow section 82 may communicate with the hollow section 41 on the upstream side and with the opening 62 of the cooling element 60 on the downstream side.

Additionally, part of the portion facing the hollow section 82 of the guide member 81 may be in contact with the flavor source 40. By having the portion facing the hollow section 82 of the guide member 81 in contact with the flavor source 40, it is possible to prevent the flavor source 40 from moving downstream. In this case, it is preferable that the guide member 81 and the flavor source 40 are partially in contact to ensure the sixth air passage 136.

If the flavor generating article 20 includes the guide member 81, the support element 50 may be provided between the flavor source 40 and the guide member 81. The support element 50 can prevent the flavor source 40 from moving downstream. In this case, to suppress the adsorption of aerosol by the support element 50, it is preferable that the support element 50 is made of a non-porous material, such as glass. The support element 50 may have multiple holes or grooves penetrating in the longitudinal direction on the side or near the outer edge of the support element 50.

As shown by the arrows in FIGS. 14 and 15, air flowing in from the plug element 30 of the flavor generating article 20 passes through the fifth air passage 135 and the sixth air passage 136, is mixed with the flavor or aerosol, is cooled by the cooling element 60, and then passes through the filter element 70 to reach the user's mouth.

At this time, the fast-flowing flavor generated in the second portion 43 and passing through the sixth air passage 136 collides with the guide member 81 and is directed toward the hollow section 41, and is mixed with the aerosol generated in the first portion 42 and passing through the fifth air passage 135 before reaching the proximal end of the flavor generating article 20. Therefore, it is possible to efficiently mix the flavor generated in the second portion 43 with the aerosol generated in the first portion 42.

The embodiments of the present invention have been described above, but the embodiments of the invention described above are for facilitating the understanding of the present invention and do not limit the present invention. The present invention can be modified and improved without departing from the spirit thereof, and equivalents thereof are included in the present invention. Additionally, within the scope that can solve at least part of the above-described problems or achieve at least part of the effects, combinations or omissions of the components described in the claims and the specification are possible.

For example, in this embodiment, a pin-type antenna 106 is mentioned as the antenna, but it is not limited to this, and the antenna may be a planar antenna or the like. Additionally, the antenna does not necessarily need to be inserted into the flavor generating article 20 and may be arranged adjacent to the flavor generating article 20 on the inner surface of the housing 112 corresponding to the chamber in a direction orthogonal to the longitudinal direction.

In this embodiment, the flavor generating article 20 is described as having a columnar shape, but the flavor generating article 20 is not limited to this and may have a flat shape, cup shape, etc. The cross section of the flavor generating article 20 may be circular, elliptical, or other shapes, such as rectangular or other polygonal cross sections. If the flavor generating article 20 is cup-shaped, it is preferable to use a material with a relative permittivity of 10 or less, preferably 4 or less, as the material constituting the cup. Specifically, the material constituting the cup may be paper made from raw materials such as glass, rock wool, or ceramic (e.g., glass fiber filter paper), nonwoven fabric, or a porous molded body.

Additionally, the flavor inhaler 100 of this embodiment has a so-called counterflow air passage, where air flowing in from the upstream side of the chamber 114 where the flavor source 40 is accommodated is supplied to the upstream end face of the flavor generating article 20, but it is not limited to this and may have a so-called bottom flow air passage, where air is supplied from the bottom of the chamber 114 to the upstream end face of the flavor generating article 20.

### REFERENCE SIGNS LIST

10 . . . Flavor inhalation system
20 . . . Flavor generating article
21 . . . Tubular element
22 . . . Sealing section
30 . . . Plug element
40 . . . Flavor source
41 . . . Hollow section
42 . . . First portion
43 . . . Second portion
44 . . . Gap
50 . . . Support element
51 . . . Opening
60 . . . Cooling element
61 . . . Through-hole
62 . . . Opening
70 . . . Filter element
80 . . . Tip paper
81 . . . Guide member
82 . . . Hollow section
83 . . . Opening
84 . . . Opening
90 . . . Microwave absorber
100 . . . Flavor inhaler
101 . . . High-frequency oscillation unit
102 . . . Waveguide
103 . . . Battery
104 . . . PCB
106 . . . Pin-type antenna
108 . . . Antenna mount
110 . . . Support section
112 . . . Housing
114 . . . Chamber
121 . . . First region
122 . . . Second region
131 . . . First air passage
132 . . . Second air passage
133 . . . Third air passage
134 . . . Fourth air passage
135 . . . Fifth air passage
136 . . . Sixth air passage

1-12. (canceled)

13. A flavor inhalation system comprising:
a flavor generating article having a flavor source that generates flavor when heated; and
a flavor inhaler comprising:
a chamber that accommodates the flavor source, and
an antenna that emits microwaves, wherein
a first region, which includes a region where an electric field intensity of the microwaves emitted from the antenna is strongest, and a second region, where the electric field intensity is weaker than in the first region, are formed within the chamber,
the flavor source, when the flavor generating article is positioned at a desired position in the flavor inhaler, includes a first portion corresponding to the first region and a second portion corresponding to the second region,
the first portion does not contain carbonizable substances that easily carbonize upon heating, and
the second portion contains the carbonizable substances.

14. The flavor inhalation system of claim 13, wherein
the antenna is a pin-type antenna that is inserted along a longitudinal direction of the flavor generating article,
the first region is a region near a tip of the pin-type antenna, and
the second region is a region near a base end of the pin-type antenna.

15. The flavor inhalation system of claim 13, wherein
the antenna is a pin-type antenna that is inserted along a longitudinal direction of the flavor generating article,
the first region is a region near a tip of the pin-type antenna, and
the second region is a region on an opposite side of the tip of the pin-type antenna from a base end of the pin-type antenna.

16. The flavor inhalation system of claim 13, wherein
the first region is a region close to the antenna in a direction orthogonal to a longitudinal direction of the flavor generating article, and
the second region is a region far from the antenna in the direction orthogonal to the longitudinal direction.

17. The flavor inhalation system of claim 14, wherein the flavor source has a hollow portion into which the pin-type antenna is insertable.

18. The flavor inhalation system of claim 14, wherein, when the flavor generating article is positioned at the desired position in the flavor inhaler, the tip of the pin-type antenna is arranged to overlap with the flavor source in the longitudinal direction of the flavor generating article.

19. The flavor inhalation system of claim 13, wherein
the first portion includes an aerosol generating substance that generates an aerosol when heated, and
the second portion includes a flavor generating substance that generates flavor when heated.

20. The flavor inhalation system of claim 19, wherein the aerosol generating substance comprises a polyhydric alcohol.

21. The flavor inhalation system of claim 20, wherein the polyhydric alcohol is at least one selected from the group consisting of glycerin, propylene glycol, triacetin, and 1,3-butanediol.

22. The flavor inhalation system of claim 19, wherein the flavor generating substance comprises tobacco.

23. The flavor inhalation system of claim 14, wherein the flavor generating article further comprises:
an outer member that surrounds an outer periphery of the flavor source and forms a gap with the flavor source;
a first air passage formed in the outer member and the first portion such that the first air passage allows an exterior of the flavor generating article to communicate with at least the first portion in a sealed manner; and
a second air passage formed in the second portion such that the second air passage allows at least the second portion to communicate with the gap.

24. The flavor inhalation system of claim 16, wherein the flavor generating article further comprises:
an outer member that surrounds an outer periphery of the flavor source and forms a gap with the flavor source;
a third air passage formed, on a proximal end side of the flavor generating article, in the outer member, the first portion, and the second portion, such that the third air passage allows an exterior of the flavor generating article to communicate with at least the first portion in a sealed manner; and
a fourth air passage formed, on a distal end side of the flavor generating article, in at least the second portion, such that the fourth air passage allows at least the second portion to communicate with the gap.

25. The flavor inhalation system of claim 16, wherein
the flavor source has a hollow portion into which the antenna is insertable, and
the flavor generating article further comprises:
an outer member that surrounds an outer periphery of the flavor source and forms a gap with the flavor source;
a fifth air passage formed in the hollow portion; and
a sixth air passage formed in the gap, the sixth air passage having a smaller flow path area than the fifth air passage, and merging with the fifth air passage before reaching a proximal end of the flavor generating article.

26. The flavor inhalation system of claim 25, wherein the flavor generating article further comprises a guide member that directs air passing through the sixth air passage toward the hollow portion.

27. The flavor inhalation system of claim 13, wherein the second portion includes a microwave absorber that absorbs microwaves and generates heat.

28. The flavor inhalation system of claim 13, wherein a distance between a tip of the antenna in a longitudinal direction of the flavor generating article and the second portion is 0.1 mm or more.

29. The flavor inhalation system of claim 28, wherein the distance between the tip of the antenna in the longitudinal direction and the second portion is 0.5 mm or more and 3.0 mm or less.

30. The flavor inhalation system of claim 16, wherein a distance between a center of the antenna and the second portion in a radial direction is 0.1 mm or more.

31. A flavor generating article comprising:
a flavor source that generates flavor when heated by microwaves, the flavor source including:
a first portion that includes an aerosol generating substance that generates an aerosol when heated, and that does not contain carbonizable substances that easily carbonize upon heating, and
a second portion that includes a flavor generating substance that generates flavor when heated, and that contains the carbonizable substances; and
an outer member that surrounds an outer periphery of the flavor source and forms a gap with the flavor source.

32. A flavor inhalation system comprising:
a flavor generating article having a flavor source that generates flavor when heated, the flavor source having a hollow portion; and
a flavor inhaler comprising:
a chamber that accommodates the flavor source, and
a pin-type antenna that emits microwaves and that is insertable into the hollow portion along a longitudinal direction of the flavor generating article, wherein
a first region, which includes a region near a tip of the pin-type antenna where an electric field intensity of the microwaves emitted from the pin-type antenna is strongest, and a second region, where the electric field intensity is weaker than in the first region, are formed within the chamber,
the flavor source, when the flavor generating article is positioned at a desired position in the flavor inhaler, includes a first portion corresponding to the first region and a second portion corresponding to the second region,
the first portion includes an aerosol generating substance that generates an aerosol when heated, and does not contain carbonizable substances that easily carbonize upon heating,
the second portion includes a flavor generating substance that generates flavor when heated, contains the carbonizable substances, and includes a microwave absorber that absorbs microwaves and generates heat, and
a distance between the tip of the pin-type antenna in the longitudinal direction and the second portion is 0.1 mm or more.
